(19) United States
(12) Patent Application Publication
(10) Pub. No.: US 2007/0120959 A1
(43) Pub. Date: May 31, 2007

(54) Smart power-saving conversation mode switching system and method therefor

(76) Inventors: Hung-Wei Wu, Taichung City (TW); Huan-Ming Chang, Taipei County (TW); Kuo-Hua Wu, Taipei County (TW)

Correspondence Address: HARNESS, DICKEY & PIERCE, P.L.C., P.O. BOX 8910, RESTON, VA, 20195, US

(21) Appl. No.: 11/340,691

(22) Filed: Jan. 27, 2006

(30) Foreign Application Priority Data
Nov. 15, 2005 (TW) 094140114

(51) Int. Cl. H04N 7/14

(52) U.S. Cl. 348/14.02

(57) ABSTRACT

A smart power-saving conversation mode switching system and method therefor are applied to a mobile communication device with a single-mode communication system or a multiple-mode communication system. If there is a low-battery warning during a conversation, software may determine to automatically switch the current conversation mode to a power-saving mode for a user to continue with the communication service. This can elongate the conversation time and avoid interruption due to insufficient power supply.

### CROSS-REFERENCE TO RELATED APPLICATIONS

This non-provisional application claims priority under 35 U.S.C. § 119(a) on Patent Application No. 094140114 filed in Taiwan, R.O.C. on Nov. 15, 2005, the entire contents of which are hereby incorporated by reference.

### BACKGROUND OF THE INVENTION

1. Field of Invention

The invention relates to a switching system of the conversation mode in a mobile communication device and method therefor. In particular, when there is a low-battery warning during a conversation, the system and method automatically switch the conversation mode in accordance with the power consumption rate.

2. Description of Related Art

With continuous advances in the hardware and software of communication systems and the transmission bandwidth, “multiple-mode communication system integration” and “video-conferencing conversation mode” are very likely to become the mainstream in future mobile communications. In particular, “the multiple-mode communication system integration” can provide users with communication services without boundaries. As long as any user has a mobile communication device, the user can enjoy the communication services wherever the user goes. This enlarges the service range of the mobile communication devices. The “video-conferencing conversation mode” is anticipated by user because it can provide many multimedia services in addition to text and voices. The fact that these two applications will become the mainstream of the field can be seen in the third generation of mobile communication era.

However, it is expected that the video-conferencing conversation mode will impose large pressure and constraints on the battery design. There have been many technical means in the prior art to lower the power consumption during the conversation services of the mobile communication devices. Nevertheless, these means can only save very limited amount of power. Therefore, unless there is some breakthrough in the design of batteries for mobile communication devices, it is necessary to find another method to properly control the power consumption during communications so as to extend the communication service time as long as possible.

It is therefore of great importance to provide a smart power-saving conversation mechanism in the future communication system and mobile communication devices in such a way that the user can maintain longer conversation when a low-battery warning is prompted during a long conversation. This can avoid service interruptions due to insufficient power.

### SUMMARY OF THE INVENTION

In view of the foregoing, the invention provides a smart power-saving conversation mode switching system and method therefor. Software is used to implement smart switching among different conversation modes. The invention can extend communication service time for the user and prevent service interruptions due to insufficient power.

The invention can be used with mobile communication devices with a single-mode communication system or a multiple-mode communication system. Basically, the entire smart power-saving conversation mode switching system according to a first embodiment of the mobile communication device with the single-mode communication system includes a battery, a lower-battery detecting unit, a conversation mode determining unit, a conversation mode switching unit, a display unit, and a user conversation interface.

In accordance with a second embodiment of the mobile communication device with the multiple-mode communication system, the conversation mode determining unit of the disclosed switching system is further added with a priority table of conversation modes for switching between different modes in the multiple-mode communication system.

The smart power-saving conversation mode switching method disclosed herein includes the following steps for the first embodiment. When a low battery signal is received from the low battery detecting unit, the setting of current conversation mode of the mobile communication device is determined. If the conversation mode is the video conferencing conversation mode, then the mobile communication device is switched to the voice conversation mode to save power. In this moment, the switch setting of the mobile communication device needs to be checked. Only when it is set to automatic can the disclosed system make an automatic switch. Therefore, the video conferencing conversation mode in use may be automatically switched to the voice conversation mode for the user to continue a conversation. However, if the switch setting is set to manual, then the disclosed system may send out a conversation mode selection message to the user for the user to determine whether to select the voice conversation mode and thus make a mode switch. If the user selects to switch to the voice conversation mode, then the disclosed system switches from the video conferencing conversation mode in use to the voice conversation mode. If the user does not select to switch to the voice conversation mode, then the system keeps the conversation in the video-conferencing mode.

In the second embodiment of the multiple-mode communication system, the mobile communication device provides several conversation modes. Each of the conversation modes has a priority and corresponding conversation mode setting in accordance with its power consumption rate determined before hand. The only difference from the first embodiment is that once the current conversation mode setting is known, the invention first finds the priority of this conversation mode. If its priority is not the highest, then it means that there is a conversation mode with lower power consumption to use. Therefore, if the mode switching is set to automatic, then the disclosed system automatically switches to the conversation mode setting with the highest priority. If the mode switching is set to manual, then the disclosed system may sends out a conversation mode selection message to the user for the user to determine whether to select the voice conversation mode and thus make a mode switch. The system then switches to the desired conversation mode according to the user's selection.

Using the above-mentioned system and method, the invention can indeed achieve the goal of extending the time of conversation service. In addition to automatic switching, the invention also allows the user to select a desired conversation mode. In particular, in the second embodiment the invention may utilize the leftover power and the power consumption in various conversation modes to compute and estimate the available remaining time for each conversation mode to the user. The user may then decide a most appropriate mode to continue a conversation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1a is a block diagram of a first embodiment of the smart power-saving conversation mode switching system and method therefor used in a single-mode communication system;

FIG. 1b is a block diagram of a second embodiment of the smart power-saving conversation mode switching system and method therefor used in a single-mode communication system;

FIG. 2a is a block diagram of the first embodiment of the smart power-saving conversation mode switching system and method therefor used in a multiple-mode communication system;

FIG. 2b is a block diagram of the second embodiment of the smart power-saving conversation mode switching system and method therefor used in a multiple-mode communication system;

FIG. 3 is a flowchart of the smart power-saving conversation mode switching system and method used in the single-mode communication system according to the first and second embodiments of the invention;

FIG. 4 is a flowchart of the smart power-saving conversation mode switching system and method used in the multiple-mode communication system according to the first and second embodiments of the invention;

FIG. 5 shows a priority table of conversation mode of the invention; and

FIG. 6 shows a conversation mode selection message of the invention.

### DETAILED DESCRIPTION OF THE INVENTION

The invention provides a power-saving conversation mode switching system and method therefor for a mobile communication device with a single-mode communication system or a multiple-mode communication system.

With the execution of software, when there is a low-battery warning due to the conversation mode that consumes a lot of power of the mobile communication device, an intelligent determining mechanism automatically switches the device to a conversation mode that consumes less power. This may elongate the service time of communication and avoid sudden interruptions due to insufficient power. In order for the user to be able to decide the conversation mode in such situations, the invention also provides a conversation mode selection message for the user to manually select a desired conversation mode.

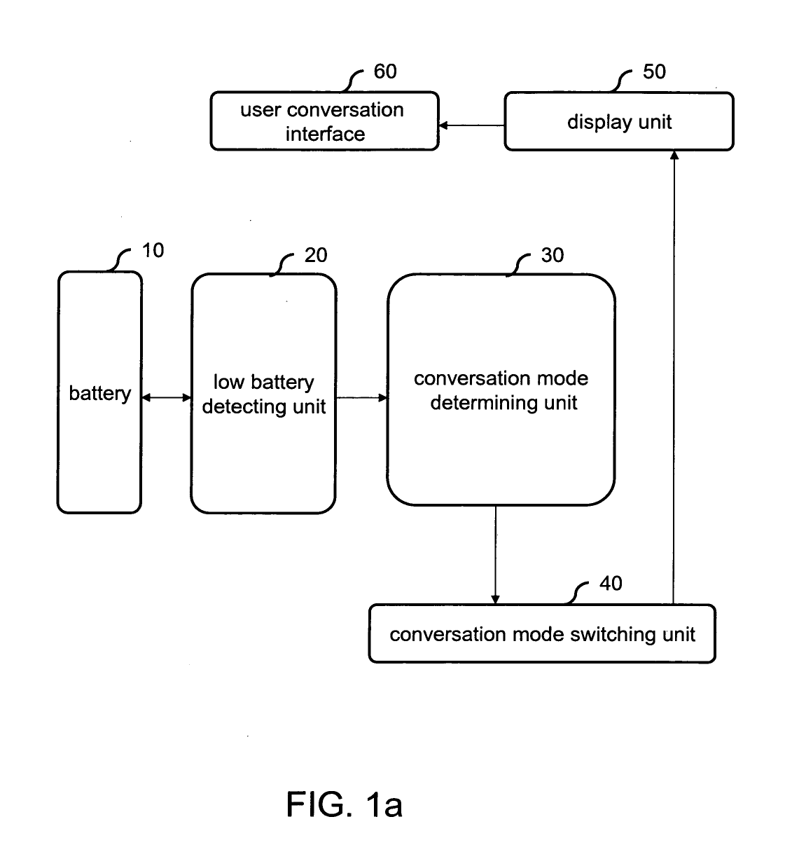

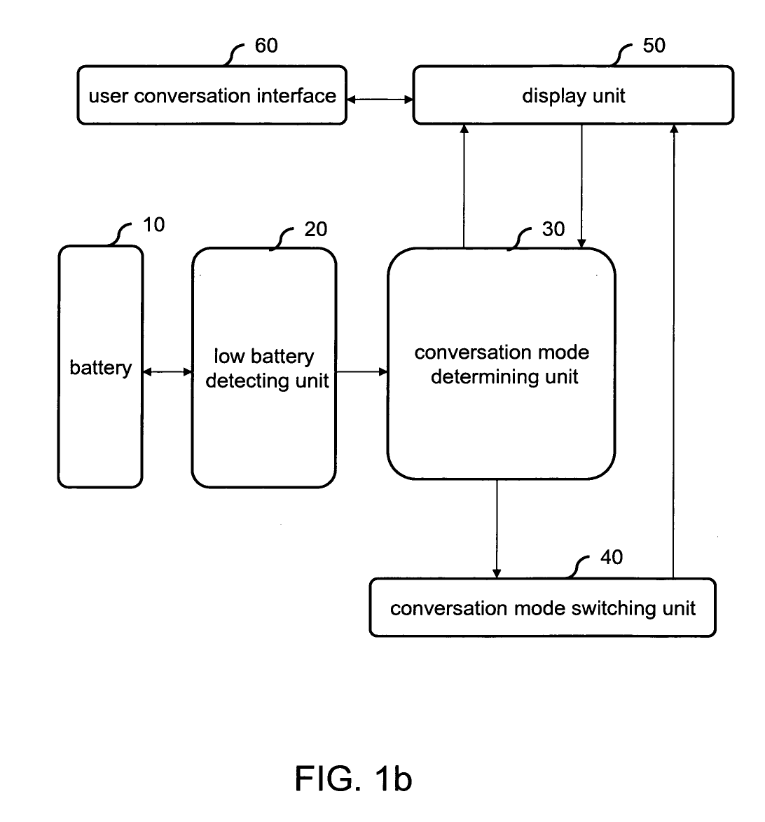

The smart power-saving conversation mode switching system in a first embodiment of the invention is applied to a mobile communication device with a single-mode communication system. Please refer to FIGS. 1a and 1b.

The smart power-saving conversation mode switching system includes a battery 10, a low battery detecting unit 20, a conversation mode determining unit 30, a conversation mode switching unit 40, a display unit 50, and a user conversation interface 60.

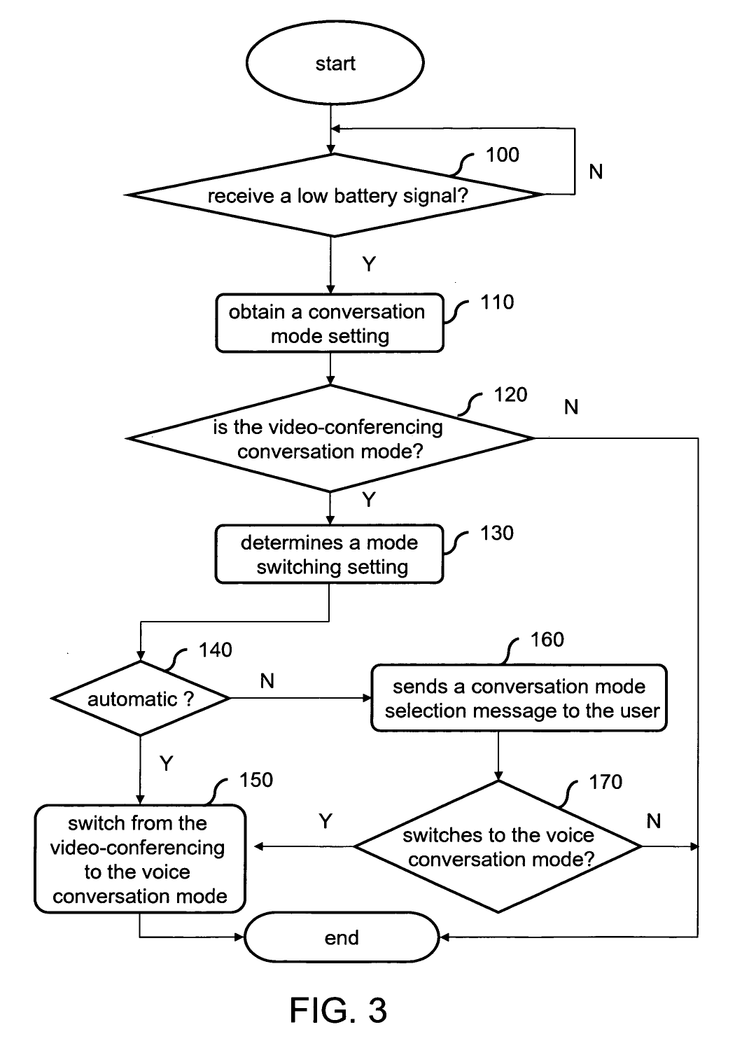

The single-mode communication system is defined as the mobile communication device that has only a single communication system. Here the single-mode communication system may provide users to conduct conversations in a video-conferencing or voice manners. Its basic operation principle is explained with reference to the flowchart in FIG. 3.

When the system starts running, the low battery detecting unit 20 continuously monitors the leftover power of the battery. When the power of the battery 10 of a mobile communication device is insufficient (usually determined by a threshold preset in the low battery detecting unit 20), the low battery detecting unit 20 sends out a low battery signal to the conversation mode determining unit 30 (step 100). The conversation mode determining unit 30 first determines the current conversation mode setting to decide whether to make any switch (step 110). If the current conversation mode setting is the video-conferencing conversation mode (step 120), then it indicates that the conversation mode setting needs to be switched to the voice conversation mode that consumes less power, and the system continues the subsequent operation. If the setting is already in the voice conversation mode, then there is no conversation mode with less power consumption, and then the procedure terminates directly.

If the conversation mode setting is the video-conferencing mode, the conversation mode determining unit 30 further determines the mode switching setting predetermined in the mobile communication device (step 130). If the mode switching setting is set to automatic (step 140), the system may automatically switch. With reference to FIG. 1a, the conversation mode determining unit 30 directly sends out a switching signal including the voice conversation mode setting to the conversation mode switching unit 40, requesting to switch from the video-conferencing conversation mode currently in use to the voice conversation mode (step 150). After the automatic switching procedure is completed, a switching message is displayed in the user conversation interface 60 via the display unit 50 for noticing the user. If the mode switching setting is set to manual (step 140), as shown in FIG. 1b, it means that the user determines whether to make any switch. In this moment, the conversation mode determining unit 30 first sends a conversation mode selection message 65 to the user conversation interface 60 via the display unit 50 for the user to select (step 160). The user may determine whether to switch to the voice conversation mode according to the user need. Once the user finishes selecting, the conversation mode determining unit 30 further determines whether the user selects to switch to the voice conversation mode (step 170). If the user selects to switch to the voice conversation mode, then the conversation mode determining unit 30 sends out a switching signal containing the voice conversation mode setting to the conversation mode switching unit 40, as in step 150, requesting to switch from the original video-conferencing conversation mode to the voice conversation mode. Otherwise, if the user didn't make a selection, no switch is made and the video-conferencing mode will remain.

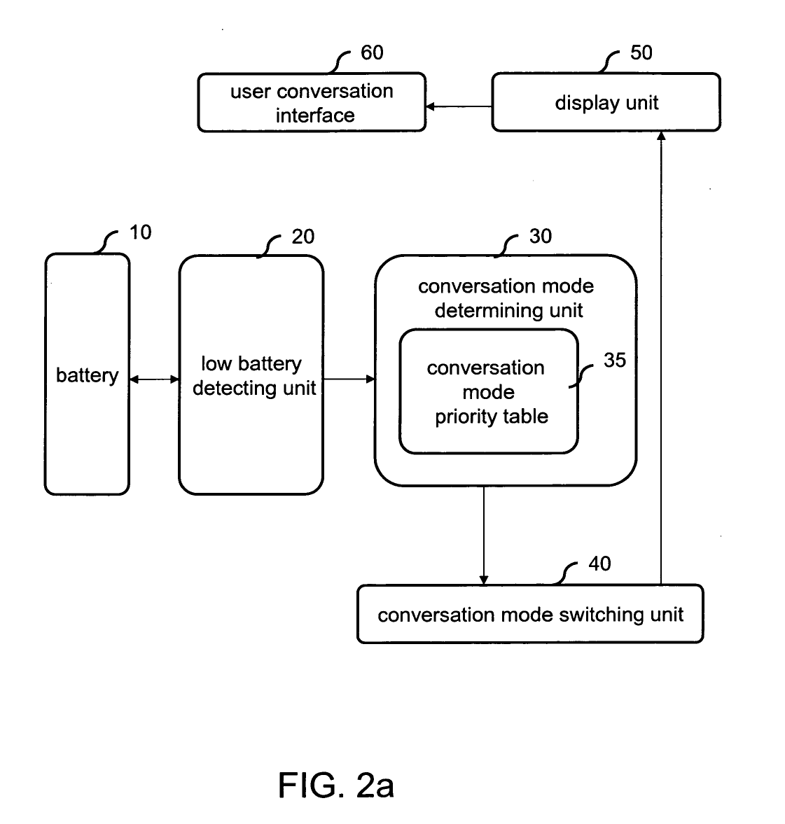

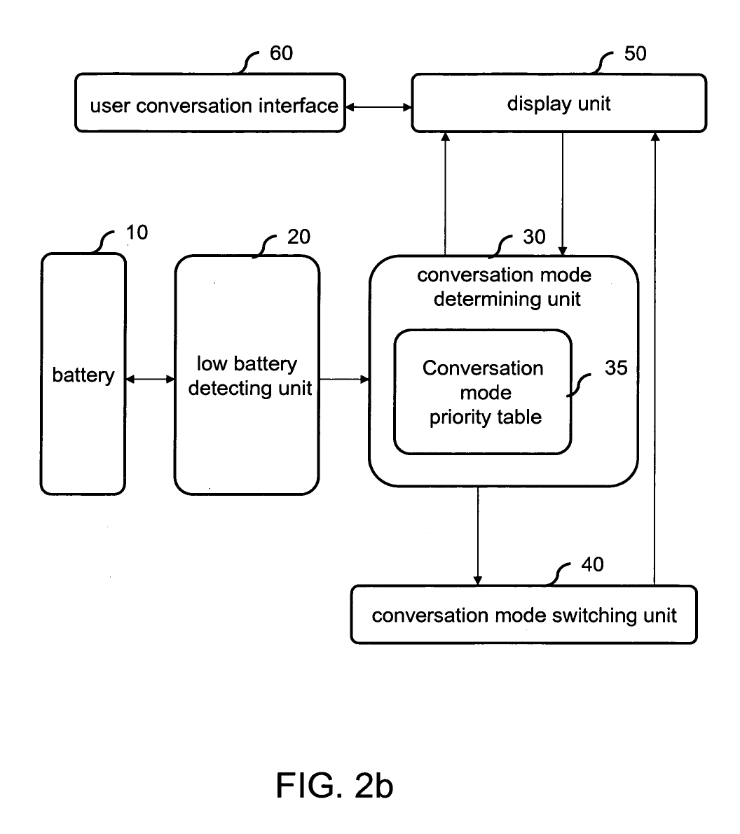

According to a second embodiment of the invention, the smart power-saving conversation mode switching system is applied to a mobile communication device with a multiple-mode communication system. With reference to FIGS. 2a and 2b, the structure is generally the same as that in the first embodiment. The only difference lies in that the conversation mode determining unit 30 is established with a conversation mode priority table 35, which is used to satisfy the needs of switching the conversation modes in the multiple-mode communication system.

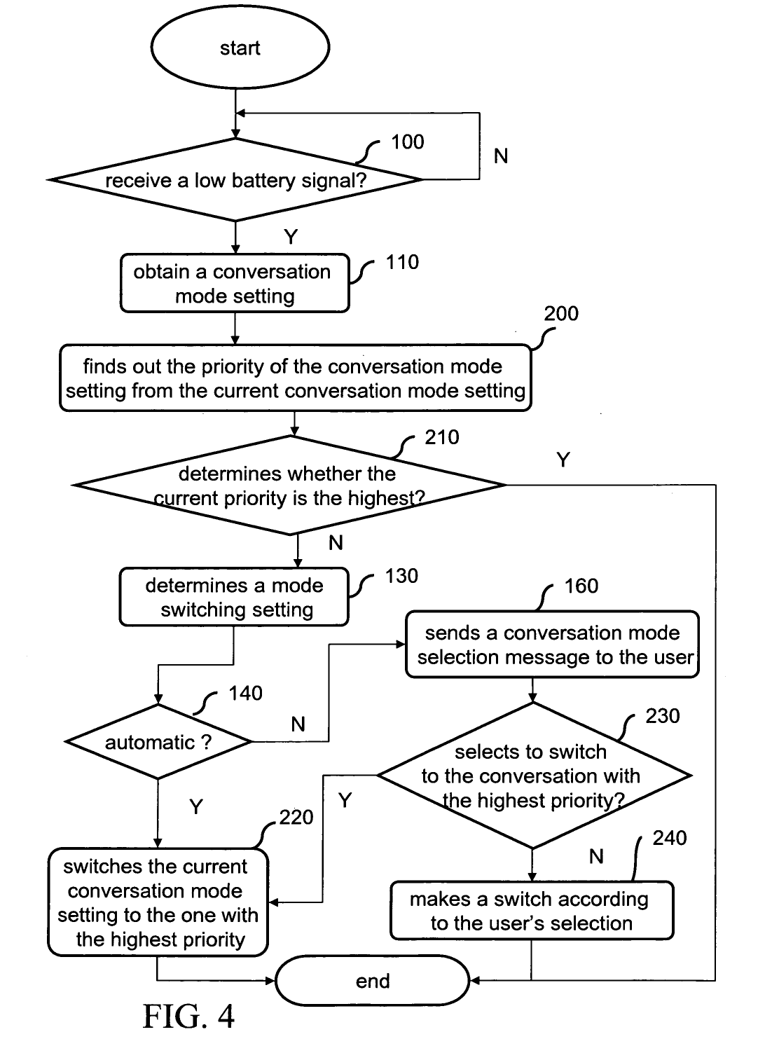

The multiple-mode communication system is defined as the mobile communication device that can select one of the multiple communication systems for conversations relative to the single-mode communication system. Some communication systems allow the user to use the above-mentioned conversation mode determining unit 30 to choose the video-conferencing conversation mode or the voice conversation mode for conversation. Its basic operation steps and procedures are explained with reference to FIG. 4.

The second embodiment has the same steps 100, 110, 130, 140, and 160 as the steps in the first embodiment. During a conversation, if the battery 10 is low, the low battery detecting unit 20 sends out a low battery signal to the conversation mode determining unit 30 (step 100). Because the mobile communication device has a multiple-mode communication system, there are many available conversation modes for switching. Moreover, the power consumption in each conversation mode is different. The conversation mode priority table 35 is used to set the priority of each conversation mode and the corresponding conversation mode setting. After obtaining the conversation mode setting in step 110, the difference from the first embodiment is that the system first finds out the priority of the conversation mode setting from the current conversation mode setting by the conversation mode determining unit 30 (step 200). The conversation mode determining unit 30 determines whether the current priority is the highest according to the content of the conversation mode priority table 35 (step 210). If the priority is not the highest, then it means there is a conversation mode with even less power consumption (i.e., higher priority) for selection. The system further determines the current mode switching setting so as to determine whether to make automatic switches (step 130). If the mode switching setting is set to automatic (step 140), with reference to FIG. 2a, the conversation mode determining unit 30 directly sends out a switching signal containing the conversation mode setting of the highest priority to the conversation mode switching unit 40, automatically switching the current conversation mode setting to the one with the highest priority (step 220). After the switching procedure is completed, a related switching message is displayed in the user conversation interface 60 via the display unit 50. If the mode switching setting is set to non-manual (that is automatic) (step 140), with reference to FIG. 2b, the conversation mode determining unit 30 first sends out a conversation mode selection message 65 to the user conversation interface 60 via the display unit 50 for the user to select, as in step 160 of the first embodiment. (However, the conversation modes provided in the conversation mode selection message 65 are limited to those accessible to the mobile communication device.) Afterwards, the system determines whether the user selects to switch to the conversation with the highest priority (step 230). If so, then step 220 is executed; otherwise, the conversation mode determining unit 30 transmits the conversation mode setting of the user selected conservation mode to the conversation mode switching unit 40 to make switches (step 240). If the user does not make any selection, then the current conversation mode will remain.

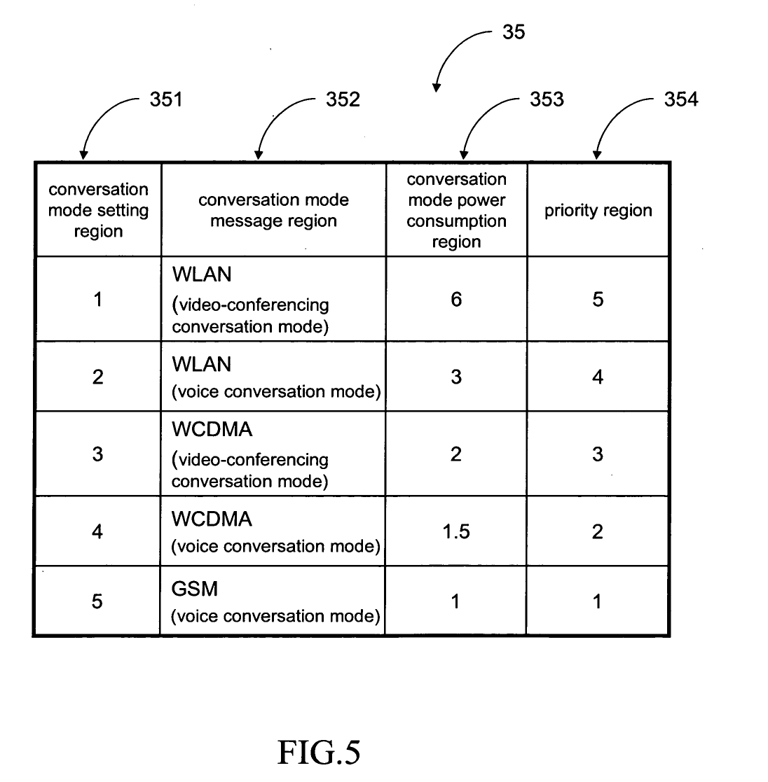

FIG. 5 shows an embodiment of the conversation mode priority table 35, which contains a conversation mode setting region 351, a conversation mode message region 352, a conversation mode power consumption region 353, and a priority region 354.

The conversation mode setting region 351 is used to store the content of each conversation mode setting for the conversation mode determining unit 30 to send to the conversation mode switching unit 40 for making switches. If the conversation mode switching unit 40 already exists various switching processes, then the conversation mode setting region 351 in the conversation mode priority table 35 only needs to provide the corresponding identification values to the conversation mode switching unit 40. In other embodiments of the invention, the table can be directly stored with switching commands. The invention does not have any restriction in this respect. The conversation mode message region 352 is mainly used to store messages of the conversation mode selection message 65. The conversation mode power consumption region 353 is used to provide estimated power consumption rates of various available conversation modes for the system to compute leftover service times in different conversation modes within the leftover power of battery 10. The computing results may display in the conversation mode selection message 65 for the user's reference. The priority region 354 basically sorts according to the power consumption rates of the different conversation modes. In principle, that is “the lower power consumption the higher priority”. Therefore, the conversation mode may depend on the priority value to choose the mode with the lowest power consumption.

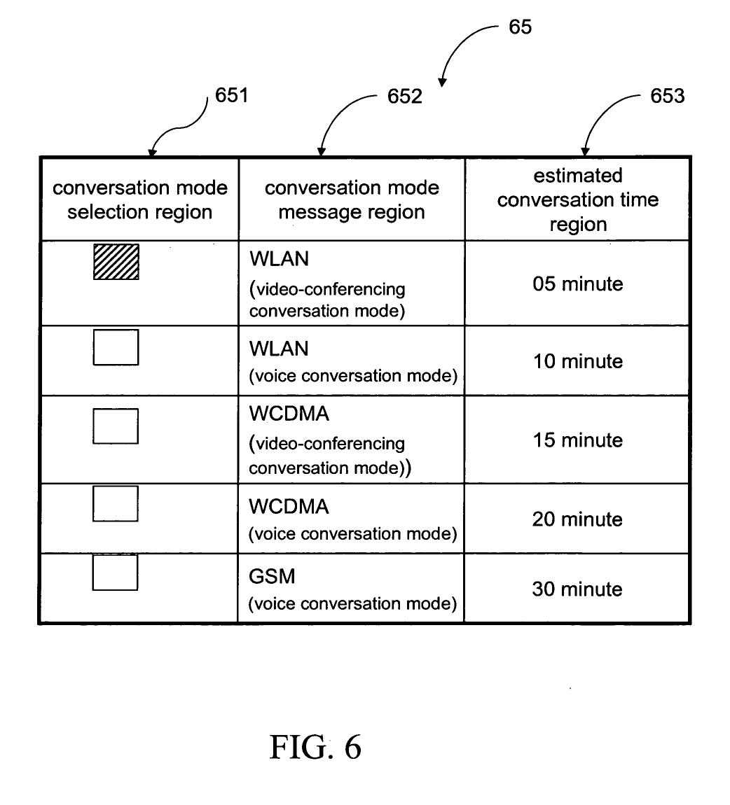

The embodiment of the conversation mode selection message 65 is shown in FIG. 6. We use the mobile communication device with the WLAN/WCDMA/GSM multiple-mode communication system as an example. WLAN is the abbreviation of Wireless Local Area Network, WCDMA is the abbreviation of Wideband Code Division Multiple Access, and GSM is the abbreviation of Global System for Mobile Communications. The conversation mode selection message 65 contains the conversation mode selection region 651 for the user to make selections (the current conversation mode can be distinguished by a different display scheme), a conversation mode message region 652 for the user to identify various conversation modes (the same content as the conversation mode message region 352 in the conversation mode priority table 35), and an estimated conversation time region 653 after the different conversation modes has been computed. Therefore, the user may accurately determine a desired conversation mode.

The operation of the above-mentioned conversation mode switching unit 40 is achieved mainly using commands or parameters contained in the conversation mode setting to drive different conversation mode interfaces. The mobile communication device has different communication system interfaces for different multiple-mode communication system to make switches. This part belongs to the prior art and not the essence of the invention. Therefore, it is not described in further detail herein.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A smart power-saving conversation mode switching method applied to a mobile communication device with a single-mode communication system, the method comprising the steps of:
receiving a low battery signal;
determining a conversation mode setting;
determining a mode switching setting when the conversation mode setting is a video-conferencing conversation mode;
switching the conversation mode from the video-conferencing conversation mode to the voice conversation mode when the mode switching setting is set to automatic; and
executing the steps of following when the mode switching setting is set to manual:
sending a conversation mode selection message for the user to select; and
determining whether to switch the conversation mode setting to the voice conversation mode in accordance with the user's selection.

2. The smart power-saving conversation mode switching method of claim 1, wherein the low battery signal is generated when the leftover battery power of the mobile communication device reaches a preset threshold.

3. The smart power-saving conversation mode switching method of claim 1, wherein the conversation mode selection message includes a conversation mode selection region, a conversation mode message region, and an estimated conversation time region.

4. The smart power-saving conversation mode switching method of claim 3, wherein the estimated conversation time in the estimated conversation time region is calculated from the leftover battery power and the power consumption rate of the conversation mode.

5. A smart power-saving conversation mode switching method applied to a mobile communication device with a multiple-mode communication system, the method comprising the steps of:
establishing a conversation mode priority table;
receiving a low battery signal;
determining a conversation mode setting;
finding a priority associated with the conversation mode setting;
determining a mode switching setting when the priority associated with the conversation mode setting is not the highest;
switching the conversation mode from the current conversation mode to the conversation mode with the highest priority when the mode switching setting is set to automatic; and
when the mode switching setting is set to manual, further comprising the steps of sending a conversation mode selection message for the user to select; and
switching to the conversation mode setting of the conversation mode in accordance with the user's selection.

6. The smart power-saving conversation mode switching method of claim 5, wherein the priorities in the conversation mode priority table are generated from the power consumption rates of the conversation modes and the conversation mode settings.

7. The smart power-saving conversation mode switching method of claim 5, wherein the conversation mode priority table includes a conversation mode setting region, a conversation mode message region, a conversation mode power consumption region, and a priority region.

8. The smart power-saving conversation mode switching method of claim 5, wherein the low battery signal is generated when the leftover battery power of the mobile communication device reaches a preset threshold.

9. The smart power-saving conversation mode switching method of claim 5, wherein the conversation mode selection message includes a conversation mode selection region, a conversation mode message region, and an estimated conversation time region.

10. The smart power-saving conversation mode switching method of claim 9, wherein the estimated conversation time in the estimated conversation time region is calculated from the leftover battery power and the power consumption rate of the conversation mode.

11. A smart power-saving conversation mode switching system applied to a mobile communication device with a single-mode communication system, comprising:
a low battery detecting unit for sending out a low battery signal in accordance with the leftover battery power;
a conversation mode determining unit, which determines a conversation mode setting when the low battery signal is received and further determines a mode switching setting when the conversation mode setting is the video-conferencing mode;
a conversation mode switching unit, which allows to automatically or manually switch from the video-conferencing conversation mode to the voice conversation mode in accordance with the mode switching setting;
wherein when the mode switching setting is set to automatic, the conversation mode setting is switched automatically from the video-conferencing conversation mode to the voice conversation mode; and
wherein when the mode switching setting is set to manual, further comprising the steps of:
sending a conversation mode selection message for the user to select; and
switching to the conversation mode setting of the conversation mode in accordance with the user's selection.

12. The smart power-saving conversation mode switching system of claim 11, wherein the low battery signal is generated when the leftover battery power of the mobile communication device reaches a preset threshold.

13. The smart power-saving conversation mode switching system of claim 11, wherein the conversation mode selection message includes a conversation mode selection region, a conversation mode message region, and an estimated conversation time region.

14. The smart power-saving conversation mode switching system of claim 13, wherein the estimated conversation time in the estimated conversation time region is calculated from the leftover battery power and the power consumption rate of the conversation mode.

15. A smart power-saving conversation mode switching system applied to a mobile communication device with a multiple-mode communication system, comprising:
a low battery detecting unit for sending out a low battery signal in accordance with the leftover battery power;
a conversation mode determining unit having a conversation mode priority table, which is used to determine a conversation mode setting when the low battery signal is received and finds a priority associated with the conversation mode setting, and further determines a mode switching setting when the conversation mode setting does not have the highest priority; and
a conversation mode switching unit, which allows to automatically or manually switch to the conversation mode setting with the desired priority in accordance with the mode switching setting when the current conversation mode setting does not have the highest priority;
wherein when the mode switching setting is set to automatic, the conversation mode setting is automatically switched to the conversation mode with the highest priority; and
wherein when the mode switching setting is set to manual, further comprising:
sending a conversation mode selection message for the user to select; and
switching the conversation mode setting to the conversation mode with the desired priority in accordance with the user's selection.

16. The smart power-saving conversation mode switching system of claim 15, wherein the priorities in the conversation mode priority table are generated from the power consumption rates of the conversation modes and the conversation mode settings.

17. The smart power-saving conversation mode switching system of claim 15, wherein the conversation mode priority table includes a conversation mode setting region, a conversation mode message region, a conversation mode power consumption region, and a priority region.

18. The smart power-saving conversation mode switching system of claim 15, wherein the low battery signal is generated when the leftover battery power of the mobile communication device reaches a preset threshold.

19. The smart power-saving conversation mode switching system of claim 15, wherein the conversation mode selection message includes a conversation mode selection region, a conversation mode message region, and an estimated conversation time region.

20. The smart power-saving conversation mode switching system of claim 19, wherein the estimated conversation time in the estimated conversation time region is calculated from the leftover battery power and the power consumption rate of the conversation mode.
